(19) United States
(12) Patent Application Publication
(10) Pub. No.: US 2011/0223370 A1
(43) Pub. Date: Sep. 15, 2011

(54) INNOVATION IN ROOFING MATERIAL

(75) Inventor: Nihadi Onal, Izmir (TR)

(73) Assignee: Selena Edustri Boya Kimya Sanayive Ticaret Limited Sirketi, Izmir (TR)

(21) Appl. No.: 13/063,902

(22) PCT Filed: Sep. 12, 2008
(86) PCT No.: PCT/TR2008/000111

§ 371 Date: May 24, 2011

(51) Int. Cl. E04D 5/02; G05D 7/06

(52) U.S. Cl. 428/74; 700/117

(57) ABSTRACT

The invention relates to a covering which has at least one visual effect on the mentioned colored mineral layer, characterized in that it is a roofing material which has at least one carrier felt, one bitume, one colored mineral layer for covering the roofing constructions of the buildings.

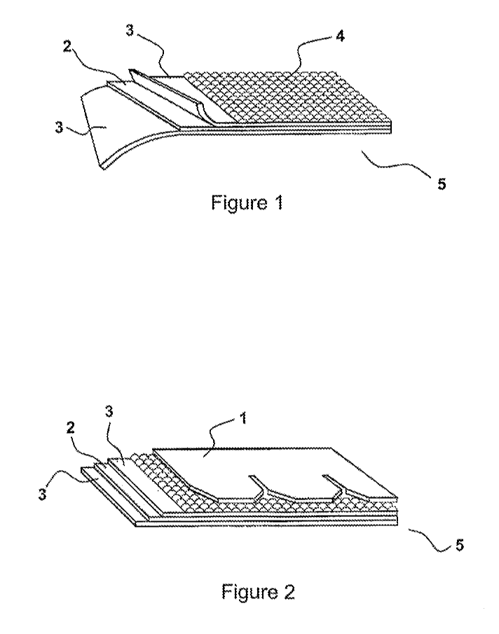

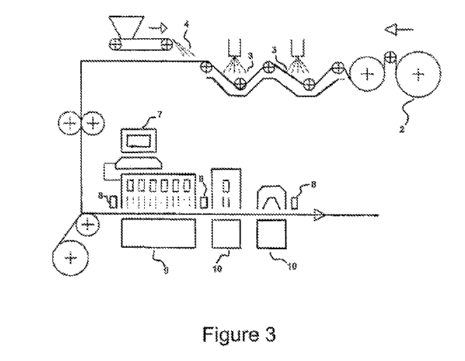

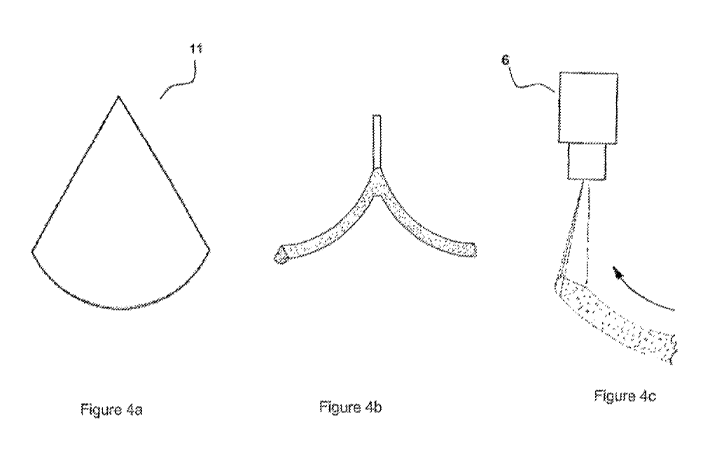

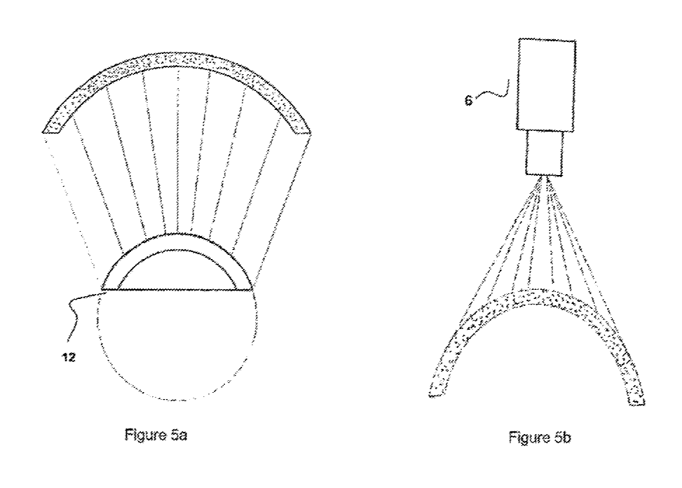

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to roofing material, used for protecting the negative effects from the upper side of the buildings and for similar objectives.

The invention related to bituminous membrane roofing material covered by granule based stone which contains a covering that has a visual effect on the facade when looked at from outside, especially to be used for all the roofing materials, known as a shingle.

2. Description of Related Art Including Information Disclosed Under 37 CFR 1.97 and 37 CFR 1.98.

The upper surface of the indoors is built as either terrace roof (flat roof) or inclined roof. For protecting the mentioned buildings from external factors (rain, snow, moisture etc.), various roofing constructions have been performed.

Beside using various sealing liquids on terrace roofs (flat roofs), mostly the applications which implement bituminous materials and adhering of membranes are preferred. As the finishing coat, bituminous membranes are adhered which are covered with colored basalt granules (minerals) for protecting the bitume from sunlight. In inclined roofs, on the contrary, generally tile or shingle is used which is metal or made of baked clay, galvanized or aluminum trapeze on the roof carcass formed by the wood or steel material on the finishing coat.

The mentioned galvanized and aluminum trapeze covering materials (one fold), which allow heat and sound, are only used in industrial buildings and of high cost. Whereas the metal tiles from the second group of the tile group are unaffordable and diathermic, the tiles made of baked clay are unstable in that they both overload on the building and have a brittle structure for the external factors. Moreover, it is a time consuming and high cost roofing method as the installment is complicated.

Furthermore, as the roofing material, known as shingle, has an advantage of isolation and of medium price; it is a roofing method which needs art and care for its shape applied in the markets and has a high potential of defect in installment and a low endurance against some external factors.

The visual unity can be obtained in that the shaped layers are furnished on the roof with rules in order to form the pattern. In furnishing, the default of furnishing rules may damage the visual unity.

In the present buildings, over roofvisual quality is quite limited. Generally; rectangular, ovoid and trapeze shaped are used and special implemented patterns are not performed.

In the publication U.S. Pat. No. 5,382,291, the above mentioned art is partially applied. In the hereby method called mineral design, fixing the stones as forming the view of shape processed on the membrane using a template of basalt granules in different colors is performed. This method is applied by colorful mineral stones forming the pattern transferred from a funnel on the template and applied by a cylinder pressing these stones. The notably limited different variations of the visual items such as figure, pattern can be used in the desired shape in the mentioned method, Also, the method is performed rather slowly and this results in high cost. This is not a preferred method due to the aforesaid drawbacks.

The method disclosed under document U.S. Pat. No. 1,392,323 A (not mentioned) is a method for applying two-dimensioned design by use of printing technique onto membrane surface covered with colourless granule. Because dye-printing cylinder does not provide colour every sides of the granule coated membrane surface (relief) and granules get stuck in the printing cylinder surface and dysfunction the system in a short time. Since digital systems were not invented in 1921, micro processor provided in our method does not closely relate to three dimensioned digital image application made with spraying and one blade edge, other edge with blurred image and less colour or multi colour and spray. Therefore, the effect structure provided on the material by our invention is considerably different from the said uniform design application and has a technological application over it. Particularly, the feature our invention reading as “. . . coating layer having three-dimensioned visual effect . . . ” is a different and superior application when compared to the document. For that reason, it is believed that our invention meets inventive step criterion in respect to the document.

### BRIEF SUMMARY OF THE INVENTION

The object of the invention from the known art is eliminating the current drawbacks with the rehabilitations on the production methods of the roofing materials used as shingle. Another object of the invention is to obtain the roofing material used for inclined and terrace roofs which are more resistible and more economic due to the external factors by the changes with production methods and sizes of the bituminous membranes whose surface is covered with granule based stones.

In the shingle piece production in the previous method, there are many shingle pieces to be used bottom up from the roof as the shingles are longitudinally short. In this installment method, the shingle is situated over and over. Therefore, installment of a shingle takes long time. The production of shingle in bigger sizes both latitudinally and longitudinally as one-piece shortens the long labor time during the installment. Due to the previous production art; as 1 m² shingle is obtained from 2.44 m² membrane in overlapping installment method, 0.95 m² shingle is obtained from 1 m² membrane in the new art due to the one-piece production. The current numerical data show that the new production technique is much more economic.

Another object of the invention is that it provides the facility for consumers even to furnish by themselves, as one-piece shingle is installed with splice, not overlapping in the installment on the roof. As a result, a cheaper labor cost and a shorter labor time are obtained.

Another object of the invention is that it eliminates the features of suppression and fouling due to the environmental conditions after the installment of shingle which is produced in small pieces in the previous art.

Another object of the invention is to prevent undesired conditions such as tearing and segregation between the holes in the shingle pieces during a strong wind or storm, because of the fact that the shingles in the previous art which are produced in small pieces are installed as overlapping.

Another object of the invention is the reduction of an additional overload by the roof, as the amount of material in unit surface is reduced compared to the other covering varieties produced as one-piece of the used shingle.

Another object of the invention is to provide a visual effect by processing the advertisings which contains message and advertisement such as theme, pattern, figure, drawing, writing on the roof in the phase of production with different methods (digital printer, template, pistol, spray, jetting) on the roof as it has a totally flat surface unlike other techniques.

### BRIEF DESCRIPTION OF THE DRAWINGS

FIG.-1 is a cross sectional view of the layers of roofing materials of the present invention.

FIG.-2 is a perpective view of the roofing material of the present invention with covering material, and position with other layers.

FIG.-3 is a flow scheme view of production of roofing material of the present invention and processing of covering layer.

FIG.-4a is a view of a nozzle form specially designed for obtaining shingle pattern on the membrane.

FIG.-4b is a view of shingle pattern of the nozzle in form of specially designed shingle.

FIG.-4c is the drawing representing the process of work designed to form the shingle pattern.

FIG.-5a is a view of a nozzle form specially designed to obtain the tile pattern on the membrane.

FIG.-5b is a view of the tile pattern of nozzle in form of specially designed tile.

### REFERENCE NUMBERS

1 Covering (drawing, logo, picture etc.)

2 Carrier felt (polyester, spun bond, polyethylene, fiberglass)

3 Bitume

4 Colored mineral layer

5 Roofing material

6 Nozzle

7 Computer

8 Sensor

9 Printer

10 Driers

11 Nozzle lead in form of shingle

12 Nozzle lead in form of tile

### DETAILED DESCRIPTION OF THE INVENTION

The application of the invention in the figures is a roofing material (5) used in the constructions to protect the effects from the upper sides of the buildings.

Differences are observed in the applications of roofing material during covering of the upper parts of the buildings. Especially, granule based stone and bituminous layered membranes are, lately, more preferred as roofing material (5).

As shown in the FIG.-1, the carrier felt (2) in the production line of the roofing material (5) is dried by passing into a heating cylinder. After that, it is immersed in the bitume (3) and bitume (3) is saturated. Then, the carrier felt (2) is covered by bitume layers (3). Next, a layer is formed by pouring the colorful minerals (4) and pressed by glazing with a press cylinder. After these processes, a covering (1) (drawing, image, logo, pattern) is formed by different techniques (digital printer, template, pistol, spray, jetting etc.).

In this type of production, when the roofing material (5) is passing through the machine in the field of production or after every kind of image or pattern can be given by painting over the material and various templates with ink or a digital industrial printer and such tools. This drawing can be applied as numerously different drawings, images or logos. The drawing to be applied is recorded to the computer memory (7) scanning by pattern or logo graphical design. When the production goes on, the printer (9) automatically begins to operate when the mineral layer reaches to the printer (9) with the help of sensors (8). The covering layer (1) is formed by spraying other colors on the roofing material (5) very rapidly by the printer (9). The drying of the mentioned covering layer (1) is provided by glazing and drying (10).

The visual effects applied on the membrane such as drawing, logo, writing and etc. can also be obtained by alternative ways. The shape which is desired to be formed on the membrane is situated on the membrane, making the template or models that contain metal or plastic. Then, the paint is sprayed manually or half mechanically on the membrane where there is a template or model.

The most important feature of the visual effects such as drawing (1), pattern, logo and etc. on the mentioned covering (1) is a 3D applicable feature. No matter from which perspective you look into the roofing material (5), it is seen that tile or shingle is furnished instead of a flat membrane. The visual descriptions desired to be obtained in the mentioned drawing process are performed by the specially designed nozzle (6). When it is desired to form a covering (1) of shingle pattern on the membrane, 3D shingle pattern is obtained by using the nozzle lead (11) in form of specially designed shingle. When a covering (1) of tile pattern on the membrane is desired to be formed, tile pattern is obtained by using the nozzle lead (12) in form of specially designed tile. The desired shape, pattern, logo and such visual effects accordingly, can be obtained by alternative nozzles (6).

The obtained roofing material (5) is, then, ready to be installed in form of roll. After that, the installment of roofing material (5) is performed by adhering from the soffit to the roof surface.

The roof, to be covered with the roofing material (5) which can be produced in the desired sizes and because of the feature of installment by splice; can be covered by using less roofing material (5). So, there is a considerable reduction in the weight of material which is loaded on the roof carcass. As there will be no hole among the layers furnished on the roof, there is no much effect of negative factors such as fouling or dust suppression. Due to the mentioned features of the roofing material (5), it is not possible to diverge from the roof because of the forcing factors such as wind.

The feature of installment, overlapping the roofing materials (5) in form of small pieces according to the prior art requires a total craftsmanship which results in a method of expensive and demanding.

The installment of the roofing material (5) in a plain format gives the opportunity of performing drawing, logo, writing and such constructions with various methods. This makes possible to obtain the views of the roof variations in different shapes.

The invention is not limited thereto, with the illustrative applications in this section. As the main factors in scope of the protection specified in the following claims; the alternative constructions by the experts shall mean the breach of the invention.

1. (canceled)

2. (canceled)

3. (canceled)

4. (canceled)

5. (canceled)

6. A production method of roofing material which has at least one carrier felt, at least one bitume layer, at least one colored mineral layer used for covering the roofing constructions of the buildings, wherein, it comprises following steps: the mentioned visual effect is transferred to the computer which has an electronic processing configuration described by the optic elements and it forms a covering which has a visual effect on the colored mineral layer with the printers having digital printer, ink, toner and such printing features by the printing instruction of the computer by means of sensors.

7. The production method according to claim 6, wherein, the visual effect is obtained by spraying paint over the template whereafter the template of any material in one-to-one size with the mentioned visual effect is situated on the colored mineral layer.

8. The production method according to claim 6, wherein, the mentioned roofing material is produced in the form of roll which has a plain surface.

9. A roofing material which obtained by method of claim 6, has at least one carrier felt, at least one bitume layer, at least one colored mineral layer used for covering the roofing constructions of the buildings, characterized in that, it comprises a covering which has at least one visual effect on the mentioned colored layer.
